(19) United States
(12) Patent Application Publication
(10) Pub. No.: US 2008/0160834 A1
(43) Pub. Date: Jul. 3, 2008

(54) Memory card with a slim USB connector

(76) Inventor: Hsiang-An Hsieh, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/826,446

(22) Filed: Jul. 16, 2007

(30) Foreign Application Priority Data
Dec. 27, 2006 (TW) 95222967

(51) Int. Cl. H01R 24/00

(52) U.S. Cl. 439/626

(57) ABSTRACT

A memory card with a slim USB connector includes a memory card and a cover. There is a slim USB connected located at one end of the memory card and the slim USB connector has a concave slot. The cover covers the slim USB connector, and there is a through hole located on the cover that corresponds to the concave slot. Thereby, the user can directly exert force onto the concave slot located on the slim USB connector, not exerting a force onto the cover, to exactly unplug the memory card. Therefore, the problem of exerting a force onto the cover to separate the cover from the memory card body while the memory card body is still in the memory slot is avoided.

### BACKGROUND OF THE INVENTION

1. Field of the Invention

The present invention relates to a memory card. In particular, this invention relates to a memory card with a slim USB connector.

2. Description of the Related Art

Because silicon storage devices, such as USB portable disks and memory cards, etc, that have non-volatile memory (such as flash memory), have particular merits, including large capacity, small size, light, low power consumption, and a rate of high data transition, etc, the storage devices have become popular with users. USB portable disks are extensively used as a periphery of personal computers for backuping, copying, or transmitting files. Memory cards are usually used in portable electronic devices, such as digital portable players, PDAs, digital still cameras, or cell phones with cameras, for storing digital medium files, such as digital music, pictures, and image files.

In order to apply the storage devices to both of personal computers and portable electronic devices, a memory card with a slim USB connector has been developed. For example, Taiwan patent T. W. M265719 discloses an SD memory card with a USB interface, and Taiwan patent T. W. M276285 discloses a memory card with two connection interfaces.

In order to easily plug the storage devices into or unplug the storage devices from a personal computer or a portable electronic device, a convex portion or a concave slot is located at the end of the memory card. Thereby, the user can easily plug or unplug the memory card by utilizing the potion of different thickness. For example, Taiwan patent T. W. 536271 discloses an IC memory card (2), while Taiwan patent T. W. 104950 discloses a memory card.

However, in order to protect the pins of the USN connector, the memory card with a slim USB connector of the prior art has a cover that covers the USB connector. When the concave slot is installed on the cover, the depth of the slot is limited due to the thickness of the cover and the cover is not firmly fastened on the end of the memory card. The cover is unplugged from the memory card and the memory card body is still in the memory slot when the user unplugs the memory card by utilizing the slot.

### SUMMARY OF THE INVENTION

One particular aspect of the present invention is to provide a memory card with a slim USB connector. The cover of the slim USB connector is easily installed and uninstalled, and the memory card can be unplugged from the attached device by utilizing the slot located at the end of the memory card.

The memory card with a slim USB connector includes a memory card having a slim USB connector located at one end of the memory card, and a cover covering on the slim USB connector. The slim USB connector has a concave slot. There is a through hole located at the cover that corresponds to the concave slot.

After the cover covers the slim USB connector of the memory card, the user can directly exert force onto the slot located on the slim USB connector via the through hole of the cover, and not exert force onto the cover, to exactly unplug the memory card. Therefore, the problem of exerting force onto the cover to make the cover separate from the memory card body while the memory card body is still in the memory slot is avoided.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an exploded perspective view of the memory card of the present invention;

FIG. 2 is another exploded perspective view of the memory card of the present invention; and

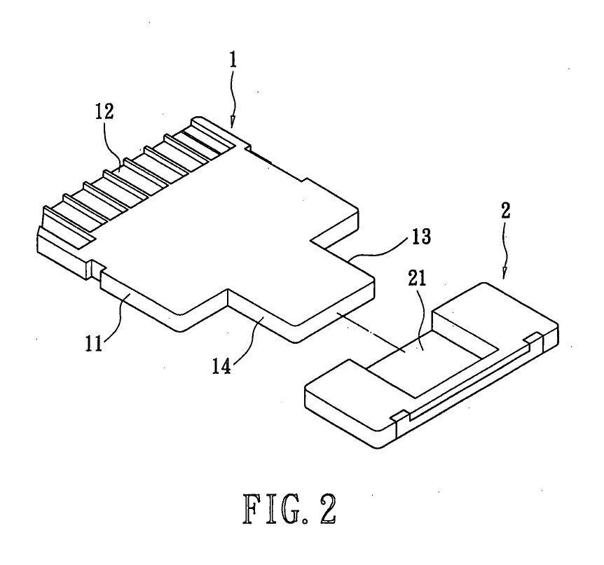

FIG. 3 is an assembly perspective view of the memory card of the present invention.

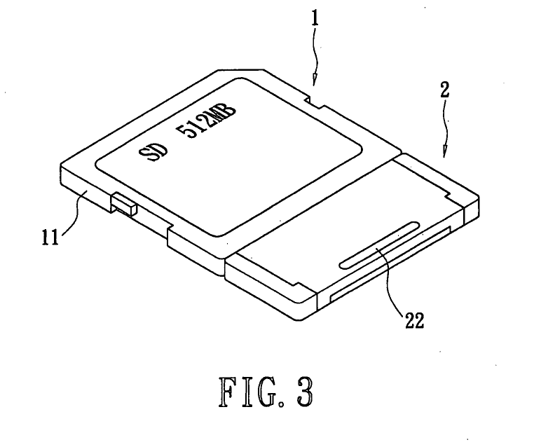

### DETAILED DESCRIPTION OF THE PREFERRED EMBODIMENTS

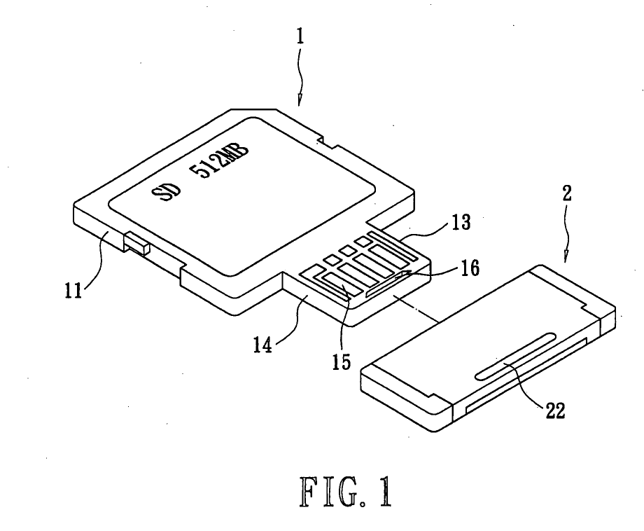

Reference is made to FIGS. 1˜3. The memory card with a slim USB connector includes a memory card 1 and a cover 2. In this embodiment, the memory card 1 is an SD memory card. The memory card 1 has a memory card body 11. The memory card body 11 has a flake shape. There is a circuit unit (not shown in the figure) in the memory card body 11. There is a plurality of memory card interface pins 12 on the memory card body 11 that match the specifications of the SD memory card. The memory card interface pins 12 are electrically connected with the circuit unit of the memory card body 11.

A slim USB connector 13 protrudes from one end of the memory card body 11. The slim USB connector 13 has a connector body 14 extending from one end of the memory card body 11. There is a plurality of USB interface pins 15 on the surface of the connector body 14. The USB interface pins 15 are electrically connected with the circuit unit of the memory card body 11. At one end of the connector body 14 of the slim USB connector 13, there is a concave slot 16. In this embodiment, the slot 16 is a rectangular slot that is adjacent to one end edge of the slim USB connector 13.

The cover 2 is a hollow cover body that covers the slim USB connector 13. Inside the cover 2, there is a receiving space 21 for receiving the slim USB connector 13. There is a through hole 22 located on the cover 2 that corresponds to the slot 16. In this embodiment, the through hole 22 is a rectangular hole. The through hole 22 passes into the receiving space 21 from an outer surface of the cover 2.

After the user covers the cover 2 on the slim USB connector 13 of the memory card, the user can directly pull the lower portion of the cover 2 via the through hole 22 of the cover 2 and exert force onto the concave slot 16 located at one end of the slim USB connector 13, not exerting force onto the cover, to exactly unplug the memory card. Therefore, the problem of exerting force onto the cover 2 to separate the cover 2 from the memory card body while the memory card is still in the memory slot is avoided.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A memory card with a slim USB connector, comprising:
a memory card having a slim USB connected located at one end of the memory card, wherein the slim USB connector has a concave slot; and
a cover covering on the slim USB connector, wherein there is a through hole located on the cover that corresponds to the concave slot.

2. The memory card with a slim USB connector as claimed in claim 1, wherein the memory card has a memory card body, and there is a plurality of memory card interface pins on the memory card body.

3. The memory card with a slim USB connector as claimed in claim 1, wherein the slim USB connector has a connector body extending from one end of the memory card, and there is a plurality of USB interface pins on the connector body.

4. The memory card with a slim USB connector as claimed in claim 1, wherein the slot is located at one end of the slim USB connector.

5. The memory card with a slim USB connector as claimed in claim 1, wherein the slot is a rectangular slot.

6. The memory card with a slim USB connector as claimed in claim 1, wherein the through hole is a rectangular hole.

7. The memory card with a slim USB connector as claimed in claim 1, wherein a receiving space is formed inside the cover for receiving the slim USB connector, and the through hole passes into receiving space from an outer surface of the cover.
